(19) United States
(12) Patent Application Publication
(10) Pub. No.: US 2003/0135383 A1
(43) Pub. Date: Jul. 17, 2003

(54) Travelable range calculation method and marketing support method

(75) Inventor: Atsumasa Mizuno, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/187,284

(22) Filed: Jul. 2, 2002

(30) Foreign Application Priority Data
Jan. 17, 2002 (JP) 2002-008141

(51) Int. Cl. G06F 17/60

(52) U.S. Cl. 705/1; 701/201; 701/204

(57) ABSTRACT

There is provided a travelable range calculation method which is capable of showing a range whose bounds can be actually reached from a predetermined point within a predetermined time period. An input for designating a travel start position for map information is received. For instance, a candidate site for a new shop can be input as the travel start position. Then, traveling speeds at which predetermined transportation means can travel along respective roads in a neighborhood around the input travel start position, the traveling speeds being dependent on a traffic congestion status of the neighborhood are acquired. For instance, a traveling speed on a road section A is 5 km per hour, and a traveling speed on a road section B is 5 km per hour. Then, coverable routes which can be covered from the travel start position within a predetermined time period are determined based on the traveling speeds on the roads.

### BACKGROUND OF THE INVENTION

1. Field of the Invention

This invention relates to a travelable range calculation method for calculating a range whose bounds can be reached from a specific point within a predetermined time period, and to a marketing support method for supporting selection of a site for opening a new store, and more particularly to a travelable range calculation method for calculating a range for travel along roads, and to a marketing support method for providing information concerning population within a commercial area.

2. Description of the Related Art

Opening a new store serves a retail company or a distribution company as a very effective method for increasing its sales and profits. At the same time, it is such a significant operation that mis-selection of a site for the new store can be fatal to the survival of the company itself. Further, quick preparation for opening a new store has been becoming extremely important so as to cope with shortening of the life cycle of each commodity in recent years.

In preparation for opening a new retail store, it is required to estimate profitability at a site for the new store beforehand. For this reason, at the planning stage, market research on a commercial area around each candidate site is carried out as part of a marketing operation, and the amount of possible sales is calculated. If the new store sells merchandise for general consumers, the larger population a commercial area around a site for the store has, the higher sales can be expected. Therefore, it is important to define the range of each possible commercial area properly.

Definition of the range of a commercial area depends on traveling times respective consumers take to travel from their residential areas to the store. For instance, when building of a shopping mall having a large parking lot is planned, a range whose bounds can be reached from the parking lot by automotive vehicle within a predetermined time period can be set as a commercial area for the shopping mall.

A range for travel by automotive vehicle within a predetermined time period can be determined based on an average speed of automotive vehicles or the like. For instance, if an automotive vehicle can travel 10 km within the predetermined time period, an area within a circle having a radius of 10 km from a candidate site is defined as a commercial area.

Actually, however, an automotive vehicle can only move along roads. For this reason, in order to define a commercial area with accuracy, it is required to correct the range of the commercial area or the population of the area. A technique for correcting the range of a commercial area was proposed e.g. by Japanese Laid-Open Patent Publication (Kokai) No. 10-240799. In this technique, an area separated from the other part of a commercial area by an obstacle, such as a river or a railroad, is excluded from the commercial area. Further, a technique for correcting the population of a commercial area was proposed e.g. by Japanese Laid-Open Patent Publication (Kokai) No. 4-363754. In this technique, when there is some obstacle, such as a river or a railroad crossing a commercial area, the number of potential customers from therebeyond is corrected.

Actually, however, a commercial area is reduced e.g. due to traffic congestion (traffic jams) on roads in an area around a store. Therefore, in the conventional method in which a commercial area is set based on a fixed time period of travel by vehicle or on foot (e.g. 1000 m per minute by vehicle or 80 m per minute on foot), a large error is caused in defining a commercial area in areas with heavy traffic, which makes it impossible to obtain accurate information. Further, the problem is that traffic congestion occurs more frequently in a densely populated area having a large number of potential customers.

To overcome the above problem in defining an exact commercial area, a method has been employed in which a person in charge of marketing actually drives around a candidate site for a new store to thereby define a commercial area based on realities. In this case, the person in charge of marketing selects and obtains necessary information concerning areas within the whole of the measured commercial area, including data of population by age group, the number of households, the number of employees by industry, changes in population, locations of schools and workplaces, and so forth, from databases, such as Grid Square Statistics of the National Census (by Statistic Bureau & Statistic Center of Ministry of Public Management, Home Affairs and Telecommunications of the Japanese Government), and then integrates numerical information items concerning the areas within the entire commercial area data into respective numerical values. Further, the person in charge plots the commercial area and sets forth numerical values of a size and other elements of the commercial area, on a real map, based on the actual measurement and the integrated numerical values to thereby prepare a marketing report.

However, as is apparent from the above, it takes time and labor to manually define a commercial area based on realities, and hence selection of a site for a new store conventionally also takes much time.

### SUMMARY OF THE INVENTION

The present invention has been made in view of these circumstances, and an object thereof is to provide a travelable range calculation method which is capable of providing a range whose bounds can be actually reached from a predetermined point within a predetermined time period.

A further object of the invention is to provide a marketing support method which is capable of providing a commercial area based on realities.

To attain the first-mentioned object, there is provided a travelable range calculation method for calculating a travelable range by a computer. This travelable range calculation method is characterized by comprising the steps of receiving an input for designating a travel start position for map information, acquiring traveling speeds at which predetermined transportation means can travel along respective roads in a neighborhood around the input travel start position, the traveling speeds being dependent on a traffic congestion status of the neighborhood around the input travel start position, and determining coverable routes or reachable points which can be covered or reached from the travel start position within a predetermined time period, based on the traveling speeds on the roads.

Further, to attain the second-mentioned object, there is provided a marketing support method for supporting marketing by a computer. This marketing support method is characterized by comprising the steps of receiving an input of a candidate site for a new store for map information, acquiring traveling speeds at which predetermined transportation means can travel along respective roads in a neighborhood around the candidate site for the new store, the traveling speeds being dependent on a traffic congestion status of the neighborhood around the candidate site for the new store, determining covetable routes or reachable points which can be covered or reached from the candidate site for the new store within a predetermined time period, based on the traveling speeds on the roads, and judging a set of areas spreading along the coverable routes or a set of areas defined based on the reachable points, as a commercial area to be formed if the new store is opened at the candidate site.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual representation of the invention which is applied to an embodiment thereof;

FIG. 2 is a diagram showing a system configuration of the embodiment;

FIG. 3 is a diagram showing an example of a hardware configuration of a marketing support apparatus used in the embodiment;

FIG. 4 is a functional block diagram showing the functional blocks of the embodiment;

FIG. 5 is a diagram showing an example of a data structure of data stored in a map information-recording section;

FIG. 6 is a diagram showing an example of a data structure of data stored in a grid square statistics-recording section;

FIG. 7 is a diagram showing an example of a data structure of data stored in a road traffic information history-recording section;

FIG. 8 is a flowchart showing a procedure of a road traffic information-storing process;

FIG. 9 is a flowchart showing a procedure of a congestion information calculation process;

FIG. 10 is a flowchart showing a procedure of a commercial area-calculating/plotting process;

FIG. 11 is a flowchart showing a procedure of a statistical data-extracting process; and

FIG. 12 is a diagram showing an example of a commercial area map image.

### DESCRIPTION OF THE PREFERRED EMBODIMENT

The invention will now be described in detail with reference to the drawings showing a preferred embodiment thereof.

First, the outline of the invention applied to the preferred embodiment will be described, and then, details of the preferred embodiment will be described.

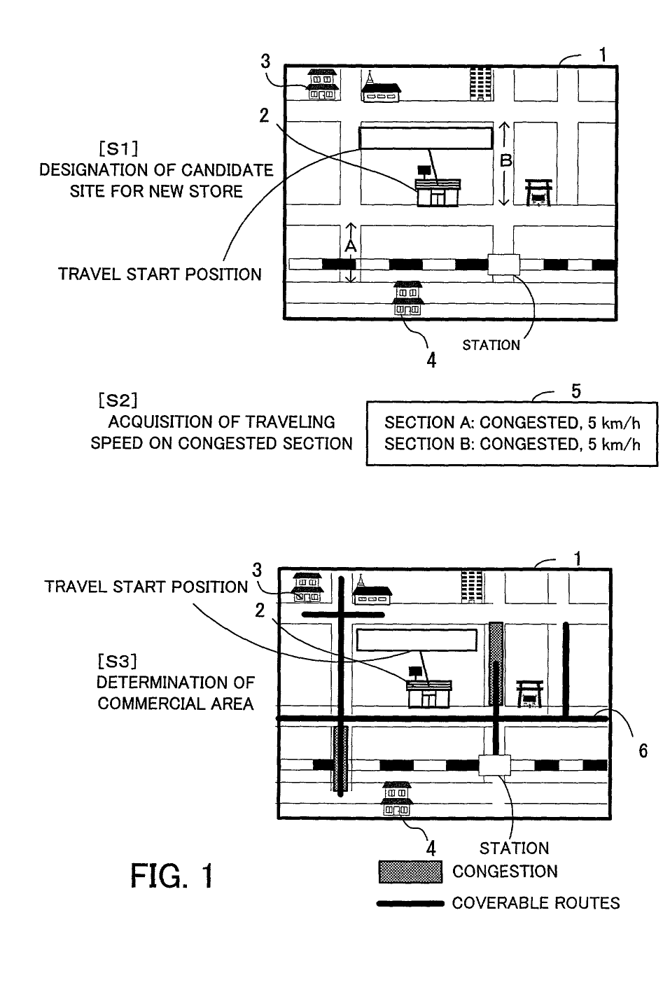

FIG. 1 is a conceptual representation of the invention applied to the embodiment. According to a travelable range calculation method of the invention, first, a designation input of a travel start position 2 for map information 1 is received (step S1). For instance, it is possible to input a candidate site for a new store to be opened, as the travel start position 2. In the illustrated example, there are residential areas 3 and 4 located at substantially equal distances from the travel start position 2. In the map information 1, roads in an area around the travel start position 2 are each divided into a plurality of sections for management. For instance, a portion of each road between adjacent two intersections is set as a section for management. In the FIG. 1 example, there are shown a section A crossing a railroad and a section B forming part of a station street.

Then, traveling speeds 5 at which predetermined transportation means travels along the road sections which are dependent on a traffic congestion state around the input travel start position 2 are acquired (step S2). For instance, traveling speeds on the respective sections A and B are both 5 km per hour. In this case, the transportation means is an automotive vehicle. The traveling speed is an average value of traveling speeds acquired over a predetermined time period in the past. The average value of traveling speeds can be calculated only from data obtained for a limited time period or time zone (e.g. business hours of the new store to be opened).

Then, routes 6 which can be covered or traveled from the travel start position 2 within a predetermined time period are determined based on the traveling speeds 5 on the roads (step S3). In this case, for instance, it is assumed that an automotive vehicle can travel at a predetermined speed (e.g. 20 km/h) on a road section without congestion. In the FIG. 1, the sections A and B are congested, and hence on a route including the section A or B, a distance which can be traveled within the predetermined time period is short. For instance, the residential area 3 can be reached within the predetermined time period because the route from the travel start position 2 to the residential area 3 does not include the section A or B, whereas the residential area 4 cannot be reached within the predetermined time period because the automotive vehicle cannot get there without passing through the section A.

According to the above travelable range calculation method, when the travel start position 2 is designated on a computer, the traveling speeds 5 dependent on the traffic congestion state around the travel start position 2 are acquired, and then the routes 6 which can be covered are determined based on the traveling speeds 5.

The coverable routes along roads are determined based on the traveling speeds dependent on the congestion state, as described above, so that it is possible to obtain coverable routes based on realities. The coverable routes can be utilized in defining a commercial area for a candidate site for a new store. A consumer living in an area along a coverable route can reach the candidate site within the predetermined time period. Accordingly, areas spreading along the coverable routes can be set as a commercial area. This method makes it possible to obtain a commercial area defined more accurately by taking congestion information into account.

Alternatively, in the step S3, reachable points may be determined. For instance, the farthest point on each road which can be reached within a predetermined period from the travel start position 2 is determined. In this case, an area defined by line segments connecting between respective adjacent two of the reachable points determined on a road-by-road basis can be set as a commercial area.

Information concerning traveling speeds of vehicles on respective congested road sections may be obtained from a public service. For instance, Japan has the VICS center which provides information by the VICS (Vehicle Information and Communication System). The VICS center collects and processes road traffic information sent from monitoring sites, and then provides traveling vehicles and the like with information through beacons (facilities for transmitting signals for allowing vehicles to confirm their positions) or a wide-area FM (frequency modulation) multiplex broadcast.

Congestion information distributed from the VICS center includes information concerning traveling speeds of vehicles. Therefore, the embodiment of the invention will be described in detail by taking as an example a case where the information concerning traveling speeds of vehicles is obtained from a center (road traffic information center), such as the VICS center, which distributes road traffic information.

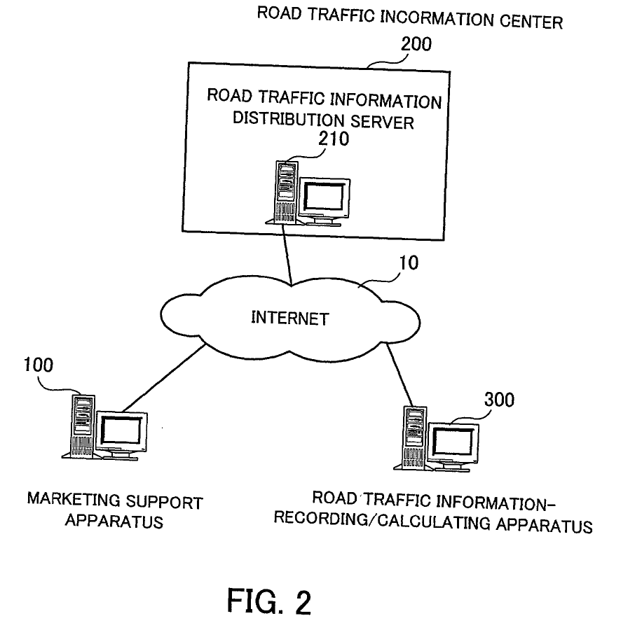

FIG. 2 shows an example of a system configuration of the present embodiment. As shown in the figure, a marketing support apparatus 100, a road traffic information distribution server 210 of the road traffic information center 200, and a road traffic information-recording/calculating apparatus 300 are connected to each other via the Internet 10.

The marketing support apparatus 100 acquires information concerning traveling speeds of vehicles and other information from the road traffic information-recording/calculating apparatus 300 in response to a user's designation of a candidate site for a new store, and then displays a possible commercial area around the candidate site and the number of potential customers.

The road traffic information center 200 is a service facility for collecting information of congestion states of respective roads by sensors each installed on a road, and distributing the collected information as congestion information. Road traffic information including the information of traveling speeds of vehicles is distributed by the road traffic information distribution server 210 of the road traffic information center 200 via the Internet 10.

The road traffic information-recording/calculating apparatus 300 periodically acquires road traffic information from the road traffic information distribution server 210, and stores the information as a history. The apparatus 300 transmits congestion information items indicative of respective average traveling speeds of vehicles in specific areas in response to a request from the marketing support apparatus 100.

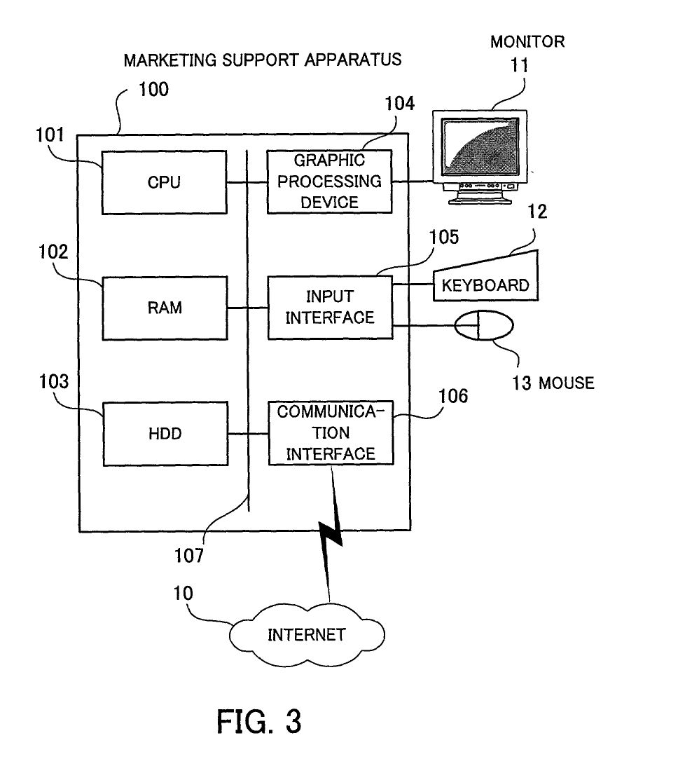

FIG. 3 shows an example of the hardware configuration of the marketing support apparatus used in the present embodiment. The overall operation of the marketing support apparatus 100 is controlled by a CPU (Central Processing Unit) 101. The CPU 101 is connected to a RAM (Random Access Memory) 102, an HDD (hard disk drive) 103, a graphic processing device 104, an input interface 105, and a communication interface 106, via a bus 107.

The RAM 102 temporarily stores at least part of programs of an OS (Operating System) and application programs, each of which is executed by the CPU 101. Further, the RAM 102 stores various kinds of data required for processing by the CPU 101. The HDD 103 stores the OS and the application programs.

The graphic processing device 104 has a monitor 11 connected thereto. The graphic processing device 104 displays an image on the screen of the monitor 11 in response to commands from the CPU 101. The input interface 105 has a keyboard 12 and a mouse 13 connected thereto. The input interface 105 transmits signals from the keyboard 12 and the mouse 13 to the CPU 101 via the bus 107.

The communication interface 106 is connected to the Internet 10. The communication interface 106 exchanges data with other computers via the Internet 10.

Processing functions of the present embodiment can be implemented by the hardware configuration describe above. It should be noted that although FIG. 3 shows only the hardware configuration of the marketing support apparatus 100, the road traffic information distribution server 210 and the road traffic information-recording/calculating apparatus 300 can be each implemented by similar hardware configuration to that of the marketing support apparatus 100.

Next, description will be given of processing functions of the respective apparatuses.

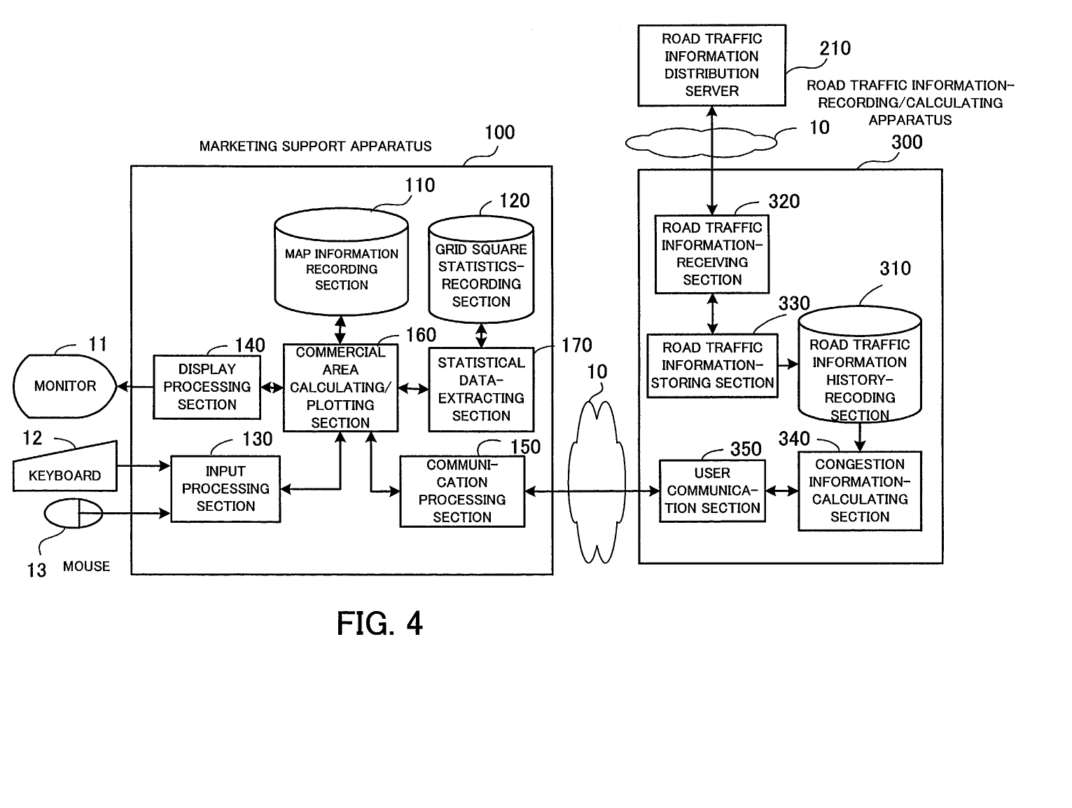

FIG. 4 shows functional blocks of the embodiment. The marketing support apparatus 100 is comprised of a map information-recording section 110, a grid square statistics-recording section 120, an input processing section 130, a display processing section 140, a communication processing section 150, a commercial area-calculating/plotting section 160, and a statistical data-extracting section 170.

Each of the sections is connected to one or more other sections for exchange of information. More specifically, connections are established, respectively, between the map information-recording section 110 and the commercial area-calculating/plotting section 160, the grid square statistics-recording section 120 and the statistical data-extracting section 170, the input processing section 130 and the commercial area-calculating/plotting section 160, the display processing section 140 and the commercial area-calculating/plotting section 160, the communication processing section 150 and the commercial area-calculating/plotting section 160, and the commercial area-calculating/plotting section 160 and the statistical data-extracting section 170.

Further, the input processing section 130 is connected to the keyboard 12 and the mouse 13, and the display processing section 140 is connected to the monitor 11.

The map information-recording section 110 stores map information of a business area of a user utilizing the marketing support apparatus 100. The map information is displayed as a map (road map), such as one utilized in an automotive vehicle navigation system, which lays emphasis on road information.

The grid square statistics-recording section 120 stores demographic statistics information. The demographic statistics information is formed e.g. by compilation of information collected by census taking. For instance, the demographic statistics information includes data of populations by age group of each area.

The input processing section 130 receives an input by operation of the user via the keyboard 12 or the mouse 13, and interprets the input. Then, the input processing section 130 sends commands and information to the commercial area-calculating/plotting section 160 according to the input.

The display processing section 140 receives image information including a map image generated by the commercial area-calculating/plotting section 160 and causes the monitor 11 to display the information on the screen thereof.

The communication processing section 150 delivers a congestion information acquisition request to the road traffic information-recording/calculating apparatus 300 via the Internet 10 in response to a request from the commercial area-calculating/plotting section 160 for acquisition of congestion information. Further, the communication processing section 150 receives the congestion information from the road traffic information-recording/calculating apparatus 300, and passes the same to the commercial area-calculating/plotting section 160.

When an arbitrary location within the map information stored in the map information-recording section 110 is designated as a candidate site for a new store by an input operation by the user, which corresponds to the step S1 in FIG. 1, the commercial area-calculating/plotting section 160 issues a request to the communication processing section 150 for acquisition of congestion information of a neighborhood around the candidate site. After receiving the congestion information from the communication processing section 150 correspondingly to the step S2 in FIG. 1, the section 160 calculates a commercial area corrected based on the traffic congestion state of the neighborhood around the candidate site, correspondingly to the step S3 in FIG. 1.

Thereafter, the commercial area-calculating/plotting section 160 issues a request to the statistical data-extracting section 170 for extraction of statistical information concerning areas within the commercial area. After receiving demographic statistics information from the statistical data-extracting section 170, the section 160 acquires map information of the commercial area from the map information-recording section 110. The section 160 processes the map information according to the demographic statistics information to generate a map image of the commercial area, and then delivers the generated commercial area map image to the display processing section 140.

After receiving the request for the extraction of statistical information concerning the areas within the commercial area from the commercial area-calculating/plotting section 160, the statistical data-extracting section 170 extracts the demographic statistics information of the commercial area of the candidate site from data stored in the grid square statistics-recording section 120. The section 170 passes the extracted demographic statistics information to the section 160.

The road traffic information-recording/calculating apparatus 300 is comprised of a road traffic information history-recording section 310, a road traffic information-receiving section 320, a road traffic information-storing section 330, a congestion information-calculating section 340, and a user communication section 350. Each of the sections is connected to one or more other sections for exchange of information. More specifically, the road traffic information-receiving section 320 is connected to the road traffic information distribution server 210 via the Internet 10. Further, connections are established, respectively, between the road traffic information-receiving section 320 and the road traffic information-storing section 330, the road traffic information-storing section 330 and the road traffic information history-recording section 310, the road traffic information history-recording section 310 and the congestion information-calculating section 340, and the congestion information-calculating section 340 and the user communication section 350. The user communication section 350 is connected to the marketing support apparatus 100 via the Internet 10.

The road traffic information history-recording section 310 is formed by a storage medium storing history of road traffic information distributed from the road traffic information distribution server 210 of the road traffic information center 200. For instance, the road traffic information history-recording section 310 forms part of a storage area within the hard disk drive of the road traffic information-recording/calculating apparatus 300.

The road traffic information-receiving section 320 periodically accesses the road traffic information distribution server 210 to receive road traffic information. The section 320 passes the received road traffic information to the road traffic information-storing section 330.

The road traffic information-storing section 330 adds bibliographic information, such as time information, to the road traffic information received from the road traffic information-receiving section 320, and then stores the resulting information in the road traffic information history-recording section 310.

Responsive to a request for acquisition of congestion information from the user communication section 350, the congestion information-calculating section 340 looks up past traffic information of the neighborhood around the candidate site for the new store in the road traffic information history-recording section 310, and calculates an average congestion level specific to each area within the neighborhood from the past road traffic information to form congestion information. For instance, an average of data values indicative of traveling speeds of vehicles, which are contained in the road traffic information, is calculated and used as congestion information. The congestion information-calculating section 340 delivers the calculated congestion information to the user communication section 350.

The user communication section 350 receives a request sent from the marketing support apparatus 100 via the Internet 10, for acquisition of congestion information, and passes the same to the congestion information-calculating section 340. Then, when receiving the congestion information from the congestion information-calculating section 340, the user communication section 350 transmits the same to the marketing support apparatus 100 via the Internet 10.

Next, data structures of respective kinds of data used in the present embodiment will be described.

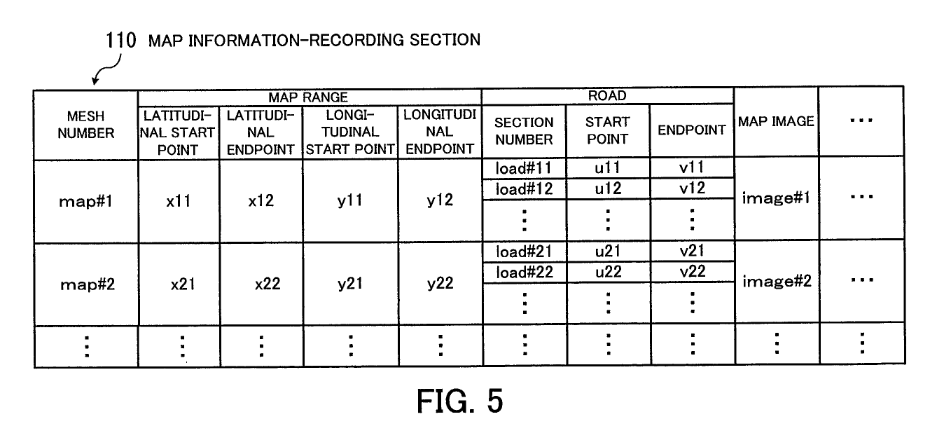

FIG. 5 shows an example of the data structure of data (map information) stored in the map information-recording section. The data stored in map information-recording section 110 has a format having columns of “mesh number”, “map range”, “roads”, “map image”, and so forth. Information items in fields on each row are associated with each other.

In the “mesh number” column, there are registered identification numbers (mesh numbers) of respective blocks or grid squares (meshes) into which the map information (map) are divided.

In each field of the “map range” column, information items defining an area represented by a block or grid square of the map information are registered. The information items are each indicative of a latitude or a longitude. The “map range” column is divided into a “latitudinal start point” column, a “latitudinal endpoint” column, a “longitudinal start point” column and a “longitudinal endpoint” column. In the “latitudinal start point” column, there are set the respective latitudes of the start points of map ranges, while in the “latitudinal endpoint” column, there are set the respective latitudes of the endpoints of the map ranges. Similarly, in the “longitudinal start point” column, there are set the respective longitudes of the start points of the map ranges, while in the “longitudinal endpoint” column, there are set the respective longitudes of the endpoints of the map ranges.

In the “road” column, there are registered information items of each of roads contained in the map information (map) divided into the meshes. The “road” column is divided into a “section number” column, a “start point” column and an “endpoint” column. In the “section number” column, there are set respective identification numbers of a plurality of sections into which each road is divided. In the “start point” column, coordinates of a start point of each section are registered, while in the “endpoint” column, coordinates of an endpoint of each section are registered. The coordinates of the start point and endpoint of each section are each represented by a latitude and a longitude.

In each field of the “map image” column, there is registered image data of a block or grid square (mesh) of the map information.

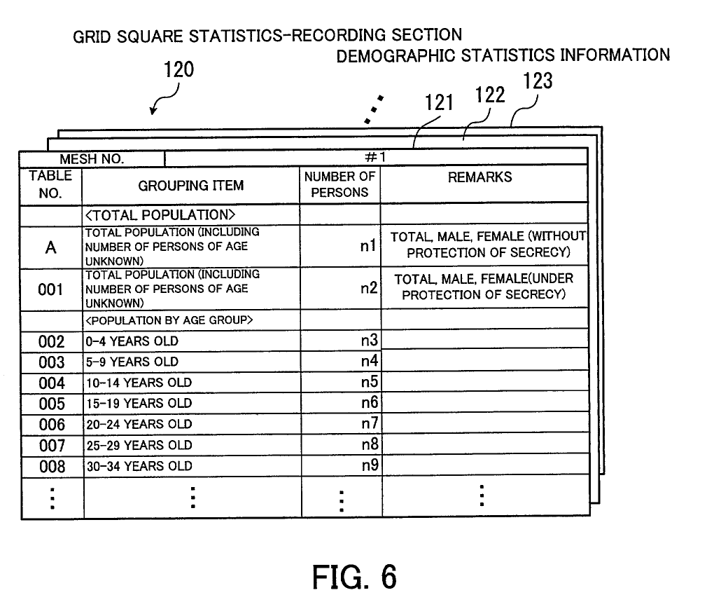

FIG. 6 shows an example of the data structure of data stored in the grid square statistics-recording section. In the FIG. 6 example, the grid square statistics-recording section 120 stores demographic statistics information lists 121, 122, 123, . . . associated with the respective blocks of the map information. Each of the demographic statistics information lists 121, 122, 123, . . . has a mesh number assigned thereto. Each list is related to the corresponding map information by its mesh number.

Further, each of the demographic statistics information lists 121, 122, 123, . . . has a format having a “table number” column, a “grouping item” column, a “number of persons” column and a “remarks” column. In the “table number” column, there are set identification numbers corresponding to respective information items contained in each of the demographic statistics information lists 121, 122, 123, . . . . In the “grouping item” column are set respective item names descriptive of the information items registered. In each field of the “number of persons” column is set the number of inhabitants corresponding to each grouping item. In each field of the “remarks” column, details of each grouping item is described. It should be noted that information in the “remarks” column in the figure is shown only for description of the invention, and the information is not always required to be stored in the grid square statistics-recording section 120.

The grouping items include various demographic statistics information items, such as “population by age group”, “nationality”, “labor force status (employed, unemployed, not in labor force)”, “status in employment (employer, self-employed, etc.)”, “industry (primary industry, secondary industry, tertiary industry, etc.)”, and so forth. Further, each demographic statistics information item is subdivided into items of “total”, “male” and “female”. FIG. 6 shows the lists in a simplified form, and the subdivided items are not shown but referred to in the “remarks” column. It should be noted that the demographic statistics information includes results obtained under protection of secrecy as well as results obtained without protection of secrecy. The protection of secrecy means a measure taken by reducing numerical values to “0” with a view to protecting secrecy of personal information when the population or the number of households in a block or grid square is very small.

Here in Japan, information contained in the demographic statistics information lists 121, 122, 123, . . . is open to the public in the form of the Grid Square Statistics of the National Census (by Statistic Bureau & Statistic Center of Ministry of Public Management, Home Affairs and Telecommunications).

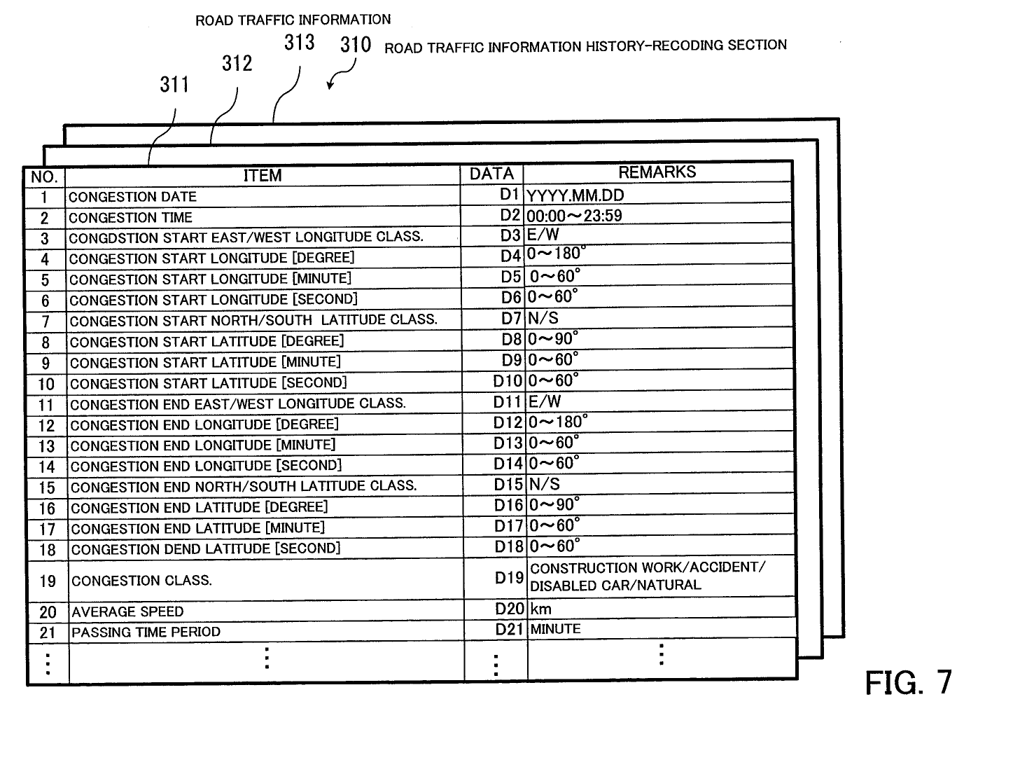

FIG. 7 shows an example of the data structure of data stored in the road traffic information history-recording section. In the road traffic information history-recording section 310, a plurality of road traffic information lists 311, 312, 313, . . . are stored on a reception time-by-reception time basis as well as on a congested section-by-congested section basis, with latitudes and longitudes as keys. In other words, an area actually indicated by each of the road traffic information lists 311, 312, 313, . . . is identified by the latitudes and longitudes of the area.

In the FIG. 7 example, the road traffic information lists 311, 312, 313, . . . each have an “item number” column, a “item” column, a “data” column and a “remarks” column. In the “item number” column, there are set identification numbers of respective information items. In the “item” column are set item names of the respective information items. In the “data” column, there are stored actual data items of the respective information items. Further, in the “remarks” column, details of each item are explained. It should be noted that information in each field of the “remarks” column in the figure is shown only for description of the invention, and hence the information is not always required to be stored in the road traffic information history-recording section 310.

For instance, in each of the road traffic information lists 311, 312, 313, . . . , there are stored information items of “congestion date”, “congestion time”, “congestion start east/west longitude classification”, “congestion start longitude (degree)”, “congestion start longitude (minute)”, “congestion start longitude (second)”, “congestion start north/south latitude classification”, “congestion start latitude (degree)”, “congestion start latitude (minute)”, “congestion start latitude (second)”, “congestion end east/west longitude classification”, “congestion end longitude (degree)”, “congestion end longitude (minute)”, “congestion end longitude (second)”, “congestion end north/south latitude classification”, “congestion end latitude (degree)”, “congestion end latitude (minute)”, “congestion end latitude (second)”, “congestion classification”, “average speed”, “passing time period”, and so forth.

The “congestion date” is a date when congestion occurred. The “congestion time” is a time in hours and minutes at which the congestion occurred. The “congestion start east/west longitude classification”, the “congestion start longitude (degree)”, the “congestion start longitude (minute)”, and the “congestion start longitude (second)” are information items for specifying the longitude of a congestion start point. The “congestion start north/south latitude classification”, the “congestion start latitude (degree)”, the “congestion start latitude (minute)”, and the “congestion start latitude (second)” are information items for specifying the latitude of the congestion start point. The “congestion end east/west longitude classification”, the “congestion end longitude (degree)”, the “congestion end longitude (minute)”, the “congestion end longitude (second)”, are information items for specifying the longitude of a congestion end point. The “congestion end north/south latitude classification”, the “congestion end latitude (degree)”, the “congestion end latitude (minute)”, and the “congestion end latitude (second)” are information items for specifying the latitude of the congestion end point. The “congestion classification” is an information item indicating a type (cause) of congestion, and the types of congestion include “construction work”, “accident”, “disabled car”, and “natural”. The “average speed” is an average traveling speed of vehicles passing through a congested section. The “passing time period” is a time period which a vehicle took to travel through the congested section.

The following processing is executed by the system having the functional configuration and data structures described above.

First, a traffic road information-storing process is executed by the road traffic information-recording/calculating apparatus 300.

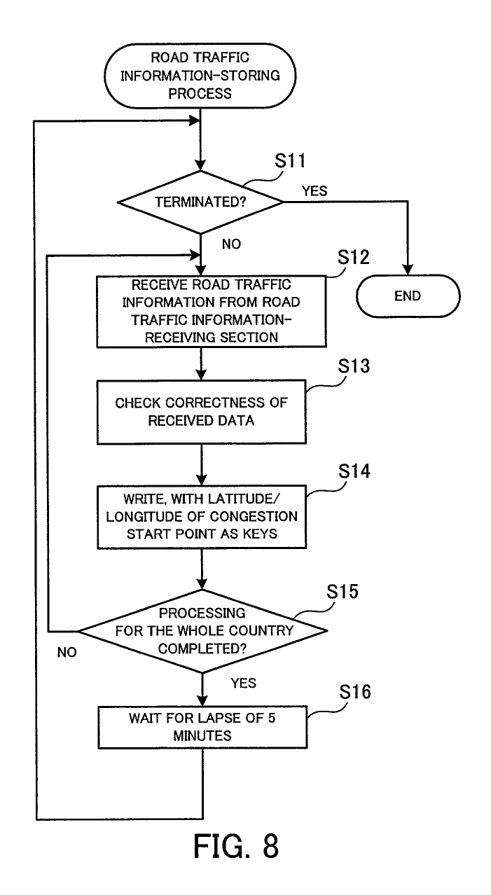

FIG. 8 shows a routine of the traffic road information-storing process. In the following, the FIG. 8 process will be described in the order of step numbers appearing in the figure.

[Step S11] The road traffic information-storing section 330 determines whether or not the traffic road information-storing process is to be terminated. The process is terminated e.g. when a manager of the road traffic information-recording/calculating apparatus 300 carries out input operation for terminating the process. If it is determined that the traffic road information-storing process is to be terminated, the process is immediately terminated, whereas if not, the process proceeds to a step S12.

[Step S12] The road traffic information-storing section 330 selects one of areas unselected through the processing loop from the step S12 to a step S15. Then, the section 330 cooperates with the road traffic information-receiving section 320 to receive road traffic information concerning the selected area from the road traffic information distribution server 210.

[Step S13] The road traffic information-storing section 330 checks correctness of the received road traffic information. For instance, it is checked whether data loss or the like has not occurred during communication. If the road traffic information is not correct, the area corresponding to the received road traffic information is returned to an unselected state so as to allow the area to be selected again in the step S12. This enables retrial of the processing for road traffic information reception. If the road traffic information is correct, the process proceeds to the step S14.

[Step S14] The road traffic information-storing section 330 writes the received road traffic information in the road traffic information history-recording section 310. In this case, the latitude and longitude of a congestion start point are used as keys. More specifically, road traffic information of a location can be extracted from the data stored in the road traffic information history-recording section 310 by designating the latitude and longitude of the location.

[Step S15] The road traffic information-storing section 330 determines whether or not the loop of the steps S12 to S15 has been executed for all areas of the whole country. If the processing has been executed for all the areas, the process proceeds to a step S16, whereas if there remains at least one area which has not been subjected to the processing, the process returns to the step S12.

[Step S16] The road traffic information-storing section 330 resets the statuses of the information items of all the areas of the whole country to the unprocessed states, and waits for a time of five minutes. Then, after the lapse of the waiting time, the process returns to the step S11.

According to the routine described above, road traffic information from all over the country is acquired every five minutes, and accumulated in the road traffic information history-recording section 310. It should be noted that the waiting time in the step S16 is not limitatively set to five minutes.

Next, a congestion information-calculating process executed by the road traffic information-recording/calculating apparatus 300 will be described.

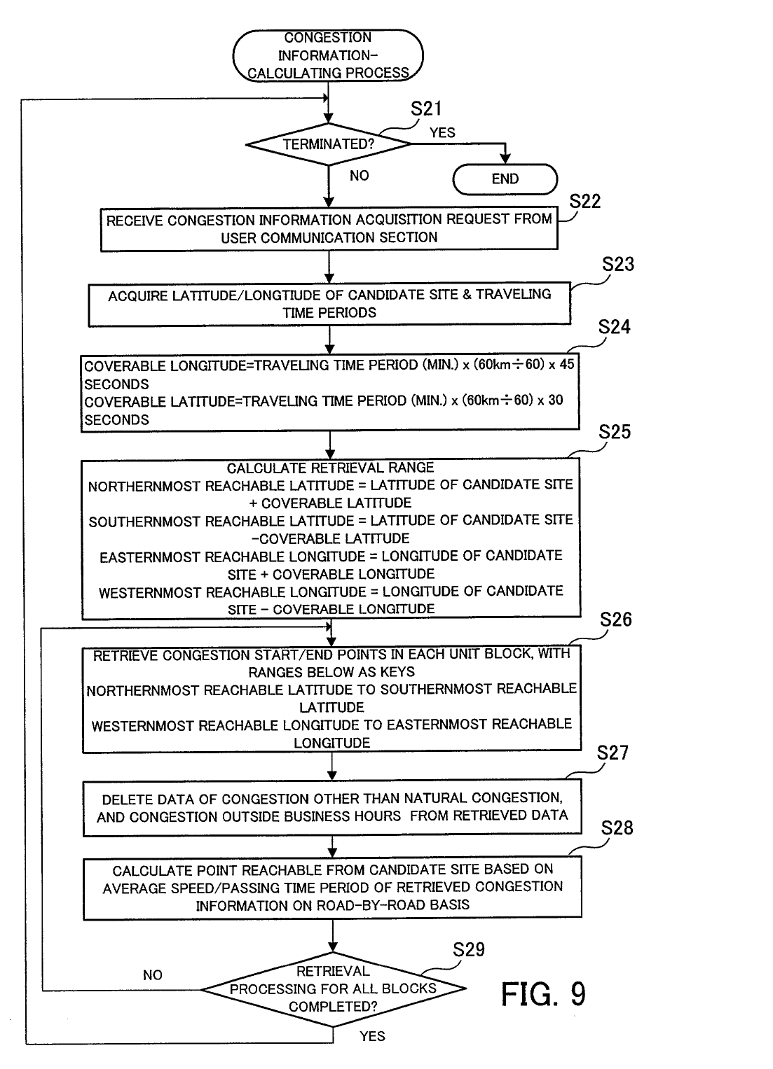

FIG. 9 shows a routine of the congestion information-calculating process. In the following, the FIG. 9 process will be described in the order of step numbers appearing in the figure.

[Step S21] The congestion information-calculating section 340 determines whether or not the congestion information-calculating process is to be terminated. The process is terminated e.g. when the manager of the road traffic information-recording/calculating apparatus 300 carries out input operation for terminating the process. If it is determined that the process is to be terminated, the process is immediately terminated, whereas if not, the process proceeds to a step S22.

[Step S22] The congestion information-calculating section 340 cooperates with the user communication section 350 to receive a congestion information acquisition request from the marketing support apparatus 100. The congestion information acquisition request includes information of a candidate site for a new store, traveling time periods, and scheduled business hours.

[Step S23] The congestion information-calculating section 340 obtains information of the latitude and longitude of the candidate site and information of the traveling time periods from the congestion information acquisition request.

[Step S24] The congestion information-calculating section 340 calculates a coverable longitude and a coverable latitude. The coverable latitude is obtained by converting a maximum distance (km) over which a vehicle can move in the north-south direction from the candidate site to a latitude value, while the coverable longitude is obtained by converting a maximum distance (km) over which a vehicle can move in the east-west direction from the candidate site to a longitude value. More specifically, the coverable longitude and the coverable latitude are calculated by using the following equations (1), (2), respectively:

Coverable longitude=traveling time period (minute)×traveling distance per minute (km/min.)×longitude change per kilometer (1)

Coverable latitude=traveling time period (minute)×traveling distance per minute (km/min.)×latitude change per kilometer (2)

In the above calculations, the traveling distance per minute (km/min.) is set to a distance over which a vehicle can travel per minute when there is no congestion. For instance, it is assumed that the vehicle can travel 60 km/h. In this connection, if there is a motorway near the candidate site, and hence the vehicle can run at a high speed, the traveling speed (traveling distance per minute) is set to a higher value (e.g. 100 km/h).

The longitude change per kilometer is set e.g. to 45 seconds. Further, the latitude change per kilometer is set e.g. to 30 seconds. It should be noted that the longitude change per kilometer differs according to the latitude of a candidate site for a new store. Therefore, the latitude change per kilometer may be calculated by using an equation based on the latitude of a candidate site.

[Step S25] The congestion information-calculating section 340 calculates a retrieval range. More specifically, a northernmost reachable latitude, a southernmost reachable latitude, a westernmost reachable longitude and an easternmost reachable longitude are calculated by using the following equations (3) to (6), respectively:

Northernmost reachable latitude=candidate site latitude+coverable latitude (3)

Southernmost reachable latitude=candidate site latitude−coverable latitude (4)

Westernmost reachable longitude=candidate site longitude+coverable longitude (5)

Easternmost reachable longitude=candidate site longitude−coverable longitude (6)

[Step S26] The congestion information-calculating section 340 selects each unit block, and retrieves road traffic information containing a congestion start point or a congestion end point within a retrieval range from the road traffic information history-recording section 310.

For instance, the congestion information-calculating section 340 retrieves road traffic information in which a latitude between the northernmost reachable latitude and the southernmost reachable latitude is set to a congestion start point or a congestion end point, from the road traffic information history-recording section 310. Then, the section 340 determines whether or not the longitude of the congestion start point or the congestion end point (whose latitude is within the retrieval range) contained in the retrieved road traffic information is between the westernmost reachable longitude and the easternmost reachable longitude. If the longitude of the congestion start point or the congestion end point is between the westernmost reachable longitude and the easternmost reachable longitude, the congestion information-calculating section 340 extracts the corresponding road traffic information from the data stored in the road traffic information history-recording section 310.

[Step S27] The congestion information-calculating section 340 deletes information items concerning congestion other than those of natural congestion from the retrieved road traffic information. For instance, information items concerning congestion of definite duration, such as congestion due to accidents or construction work, are deleted because they are unnecessary for calculation of a commercial area.

Further, the congestion information-calculating section 340 deletes road traffic information concerning congestion occurring except during scheduled business hours. This is because congestion which occurs when a store is closed does not affect the commercial area for the store. For instance, when the store is open from 10:00 AM to 9:00 PM, congestion which occurs during a rush hour from 7:00 to 8:00 in the morning cannot affect the commercial area.

[Step S28] The congestion information-calculating section 340 calculates coverable routes which can be covered or traveled from the candidate site for the new store on a road-by-road basis, based on an average speed and a passing time period contained in the retrieved congestion information.

[Step S29] The congestion information-calculating section 340 determines whether or not the retrieval processing has been carried out for all the unit blocks within the retrieval range. If the retrieval processing for all the unit blocks has been completed, the process returns to the step S21, whereas if not, the process returns to the step S26.

Next, description will be given of a commercial area-calculating/plotting process executed by the market support apparatus 100.

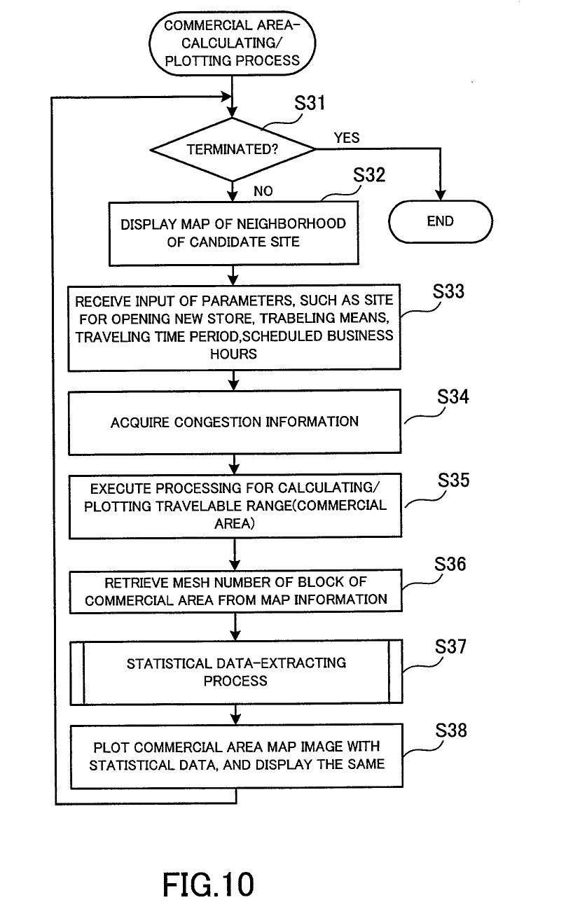

FIG. 10 shows a routine of the commercial area-calculating/plotting process. In the following, the FIG. 10 process will be described in the order of step numbers appearing in the figure.

[Step S31] The commercial area-calculating/plotting section 160 determines whether or not the commercial area-calculating/plotting process is to be terminated. The process is terminated e.g. when the user of the market support apparatus 100 carries out input operation for terminating the process. If it is determined that the process is to be terminated, the process is immediately terminated, whereas if not, the process proceeds to a step S32.

[Step S32] The commercial area-calculating/plotting section 160 retrieves map information of a neighborhood around the candidate site for the new store from the map information-recording section 110, and passes the information to the display processing section 140. The display processing section 140 displays the map information received from the commercial area-calculating/plotting section 160 on the screen of the monitor 11.

[Step S33] The input processing section 130 received inputs of parameters from an input device, such as the keyboard 12 or the mouse 13. The parameters receives by the section 130 are information items concerning the candidate site for the new store, the traveling means, the scheduled business hours, the traveling time periods, age groups of targeted customers, the gender of the targeted customers, acquisition or non-acquisition of the number of the employed, acquisition or non-acquisition of the number of day students, and so forth. The input processing section 130 passes the parameters input via the input device to the commercial area-calculating/plotting section 160.

[Step S34] The commercial area-calculating/plotting section 160 issues a request to the communication processing section 150, for acquisition of congestion information according to the parameters received from the section 130. When the request is issued, the parameters, such as the candidate site for the new store, the traveling time periods, the scheduled business hours, and so forth, are passed to the communication processing section 150. Upon reception of the parameters, the communication processing section 150 generates a congestion information acquisition request containing the received parameters, and then delivers the request to the road traffic information-recording/calculating apparatus 300 via the Internet 10. The congestion information sent from the road traffic information-recording/calculating apparatus 300 in response to the request is received by the communication processing section 150, and passed to the commercial area-calculating/plotting section 160.

[Step S35] The commercial area-calculating/plotting section 160 calculates a travelable range. The travelable range defines areas spreading along each route from the candidate site which can be covered within the predetermined traveling time period. In short, the travelable range defines commercial area of the candidate site.

If the road traffic information distribution server 210 stores only road traffic information concerning trunk roads, all congestion information that can be obtained is about the trunk roads. In this case, the travelable range is calculated on the assumption that it is possible to travel along branch roads from each trunk road at a predetermined speed. In most cases, branch roads are narrower than trunk roads. Therefore, the traveling speed of vehicles on branch roads may be set to a lower speed than that of vehicles on a trunk road without congestion.

The commercial area-calculating/plotting section 160 synthesizes the map information obtained in the step S32 and an image representing the range of the calculated commercial area to generate a map image of the commercial area. In this case, for example, the range of the commercial area is represented by a polygon, and then the polygon is made translucent and superimposed on the corresponding portion of the map information.

[Step S36] The commercial area-calculating/plotting section 160 retrieves the mesh number of a block having at least a portion thereof included in the commercial area, from the map information stored in the map information-recording section 110.

[Step S37] The commercial area-calculating/plotting section 160 notifies the statistical data-extracting section 170 of the mesh number and issues a request for extraction of statistical information. In response to this request, the statistical data-extracting section 170 consults the grid square statistics-recording section 120 for a demographic statistics information list corresponding to the designated mesh number. Then, the statistical data-extracting section 170 calculates populations matching the conditions specified by the input parameters, based on the extracted demographic statistics information list, and notifies the commercial area-calculating/plotting section 160 of statistical data obtained from the calculation. For instance, the statistical data delivered to the commercial area-calculating/plotting section 160 includes data items of populations belonging to specified age groups, populations by gender in each of the age groups, the number of the employed, and the number of day students.

[Step S38] The commercial area-calculating/plotting section 160 adds the statistical data to the commercial area map image, and then delivers the map image having the statistical data added thereto to the display processing section 140. When receiving the map image having the statistical data added thereto, the display processing section 140 displays the same on the screen of the monitor 11. Then, the process returns to the step S31.

Next, description will be given of a statistical data-extracting process executed by the marketing support apparatus 100.

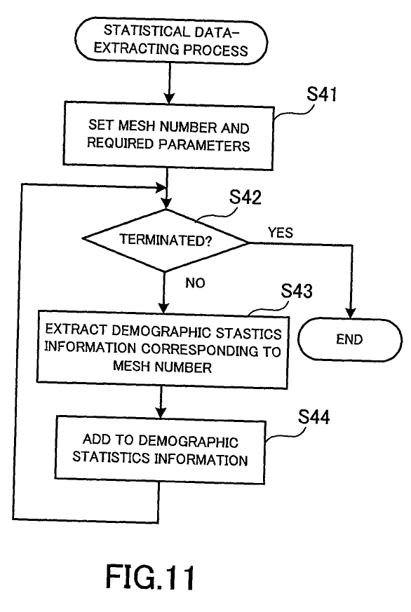

FIG. 11 shows a routine of the statistical data-extracting process. In the following, the FIG. 11 process will be described in the order of step numbers appearing in the figure.

[Step S41] The statistical data-extracting section 170 sets the one or more mesh numbers and the various parameters delivered from the commercial area-calculating/plotting section 160, as conditions for statistical data extraction.

[Step S42] The statistical data-extracting section 170 determines whether or not the present process is to be terminated. The process is terminated when processing for extraction of statistical data items corresponding to all the received mesh numbers has been completed. If it is determined that the process is to be terminated, the process is immediately terminated, whereas if not, the process proceeds to a step S43.

[Step S43] The statistical data-extracting section 170 selects one of the delivered mesh numbers and extracts demographic statistics information corresponding to the selected mesh number from the grid square statistics-recording section 120.

[Step S44] The statistical data-extracting section 170 adds the demographic statistics information extracted in the step S43 to demographic statistics information having been extracted before the present loop. Then, the process returns to the step S42.

Thus, a proper commercial area can be determined. Then, the determined commercial area and the demographic statistics information concerning consumers as potential customers living within the commercial area are displayed on the screen of the monitor 11.

FIG. 12 shows an example of a commercial area map image. The commercial area map image 500 shows a candidate site 501 for a new store, coverable trunk-road routes 510, a travelable range (commercial area) 520, and a neighborhood map divided into the meshes of a plurality of blocks 531 to 542.

The coverable trunk-road routes 510 represent routes which can be covered or traveled from the candidate site 501 along trunk roads within a predetermined traveling time period. The trunk roads are roads whose congestion states can be known by road traffic information.

The travelable range 520 is represented by a polygon formed by connecting each adjacent two of reachable points on the respective coverable routes along roads including not only the trunk roads but also branch roads by a line segment. A travelable distance on a branch road from a branch point from which the branch road branches off a trunk road can be obtained by using the following equation (7):

Travelable distance on a branch road=(travelable time−elapsed time)×travelable distance per unit time (7)

In the equation (7), the “elapsed time” represents a time period required to reach the branch point from the candidate site. A travelable distance per unit time is set according to traveling means. When a vehicle is used as traveling means, the travelable distance per unit time is set e.g. to a value of 160 m per minute (about 10 km per hour).

The blocks 531 to 542 are displayed in different display modes depending on the proportion of an area occupied by a portion of the commercial area within a block to the whole area of the block. Although in FIG. 12, differences among the blocks in the proportion of the area occupied by a portion of the commercial area are shown by different hatching patterns, actually, the monitor 11 is capable of displaying the blocks in different colors such that the differences in the proportion can be clearly distinguished from each other. The block 536 is a block of a 100% commercial area (the proportion is above 75%). The blocks 532, 533, 537, 540 are blocks of 75% commercial area (the proportion is equal to or larger than 50% and smaller than 75%). The blocks 535, 541 are blocks of 50% commercial area (the proportion is equal to or larger than 0% and smaller than 50%). Further, the blocks 531, 534, 538, 539, 542 are non-commercial area (the proportion is 0%).

The above display of the range of the commercial area on the map makes it possible to promptly determine whether or not a store should actually be opened at the candidate site. For instance, if the commercial area contains many densely built-up residential areas, large sales can be expected when the new store is opened. Further, by adding the demographic statistics information of corresponding blocks extracted by the statistical data-extracting section 170 to the map information, it is possible to estimate sales from the population of possible buyers and the like within the commercial area.

Although in the above embodiment, road traffic information is acquired via the network, it is also possible to distribute road traffic information stored in a portable recording medium such as a CD-ROM.

Further, although in the above embodiment, the marketing support apparatus 100 and the road traffic information-recording/calculating apparatus 300 are formed by respective apparatus separate from each other, the marketing support apparatus 100 may be configured to integrate the functions of the road traffic information-recording/calculating apparatus 300.

It should be noted that the above processing functions can be implemented by a server computer and a client computer. In this case, there are provided a server program describing the details of the functions which should be performed by the road traffic information-recording/calculating apparatus 300 and a client program describing the details of the functions which should be performed by the marketing support apparatus 100. The server program is executed by the server computer, whereby the processing functions of the road traffic information-recording/calculating apparatus 300 are realized on the server computer. On the other hand, the client program is executed by the client computer, whereby the processing functions of the marketing support apparatus 100 are realized on the client computer.

The server program and the client program each describing the processing details can be stored in a computer-readable recording medium. The computer-readable recording medium includes a magnetic recording device, an optical disk, a magneto-optical recording medium and a semiconductor memory. The magnetic recording device includes a hard disk drive (HDD), a flexible disk (FD)), and a magnetic tape. The optical disk includes a DVD (Digital Versatile Disk), a DVD-RAM (Random Access Memory), and a CD-ROM (Compact Disk Read Only Memory), and a CD-R (Recordable)/RW (ReWritable). Further, the magneto-optical recording medium includes an MO (Magneto-Optical disk).

To make the server program and the client program available on the market, a portable recording medium, such as a DVD or CD-ROM, which stores each of the programs, is sold. Further, the client program can be stored in a storage device of a server computer connected to a network, and transferred from the server computer to a client computer via the network.

When the server program is executed by a server computer, the server program stored e.g. in a portable recording medium is stored into a storage device of the server computer. Then, the server computer reads the server program from the storage device of its own and executes processing based on the program. The server computer can also read the program directly from the portable recording medium and execute processing based on the program.

On the other hand, when the client program is executed by a client computer, the client program stored e.g. in a portable recording medium or transferred from a server computer is stored into a storage device of the client computer. Then, the client computer reads the client program from the storage device of its own and executes processing based on the program. The client computer can also read the program directly from the portable recording medium and execute processing based on the program. Further, the client computer may also execute processing based on a client program which is sequentially transferred from the server computer whenever the processing is carried out.

As described above, according to the present invention, when a travel start position is designated, coverable routes are determined based on traveling speeds at which predetermined transportation means can travel along roads depending on a traffic congestion state of a neighborhood around the input travel start position, so that the obtained routes can reflect the realities of the roads.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A travelable range calculation method for calculating a travelable range by a computer,
the travelable range calculation method comprising the steps of:
receiving an input for designating a travel start position for map information;
acquiring traveling speeds at which predetermined transportation means can travel along respective roads in a neighborhood around the input travel start position, the traveling speeds being dependent on a traffic congestion status of the neighborhood around the input travel start position; and
determining coverable routes or reachable points which can be covered or reached from the travel start position within a predetermined time period, based on the traveling speeds on the roads.

2. A marketing support method for supporting marketing by a computer,
the marketing support method comprising the steps of:
receiving an input of a candidate site for a new store for map information;
acquiring traveling speeds at which predetermined transportation means can travel along respective roads in a neighborhood around the candidate site for the new store, the traveling speeds being dependent on a traffic congestion status of the neighborhood around the candidate site for the new store;
determining coverable routes or reachable points which can be covered or reached from the candidate site for the new store within a predetermined time period, based on the traveling speeds on the roads; and
judging a set of areas spreading along the covetable routes or a set of areas defined based on the reachable points, as a commercial area to be formed if the new store is opened at the candidate site.

3. The marketing support method according to claim 2, wherein the predetermined transportation means is traveling means implemented by an automotive vehicle.

4. The marketing support method according to claim 2, further comprising the step of displaying a map on which an inside of the commercial area and an outside of the commercial area are shown in different modes.

5. The marketing support method according to claim 4, wherein the step of displaying a map includes dividing the map into a plurality of unit blocks, and determining a display mode for displaying each of the unit blocks, according to a proportion of an area occupied by a portion of the commercial area within the unit block to a whole area of the unit block.

6. The marketing support method according to claim 2, comprising the step of consulting demographic statistics information concerning populations of the neighborhood around the candidate site for the new store, and then displaying demographic statistics information concerning populations of the commercial area.

7. The marketing support method according to claim 2, wherein the step of acquiring the traveling speeds includes acquiring a traveling speed on a trunk road, and
wherein the step of determining coverable routes or reachable points includes calculating a coverable trunk route along the trunk road, and then determining the coverable routes or the reachable points on the assumption that branch roads from the trunk road can be traveled at a predetermined traveling speed.

8. The marketing support method according to claim 2, wherein the step of judging a set of areas spreading along the coverable routes or a set of area defined based on the reachable points as a commercial area includes judging an inside of a polygon formed by connecting each adjacent two of a plurality of ends of the coverable routes or the plurality of reachable points by a line segment, as the commercial area.

9. The marketing support method according to claim 2, wherein the step of acquiring traveling speeds includes acquiring an average value of traveling speeds based on a plurality of road traffic information items acquired periodically in the past.

10. A travelable range calculation apparatus for calculating a travelable range, comprising:
input reception means for receiving an input for designating a travel start position for map information;
traveling speed acquisition means for acquiring traveling speeds at which predetermined transportation means can travel along respective roads in a neighborhood around the travel start position input to the input reception means, the traveling speeds being dependent on a traffic congestion status of the neighborhood around the travel start position; and
route determination means for determining coverable routes or reachable points which can be covered or reached from the travel start position within a predetermined time period, based on the traveling speeds on the roads acquired by the traveling speed acquisition means.

11. A marketing support apparatus for supporting marketing by a computer, comprising:
input reception means for receiving an input of a candidate site for a new store for map information;
traveling speed acquisition means for acquiring traveling speeds at which predetermined transportation means can travel along respective roads in a neighborhood around the candidate site input to the input reception means, the traveling speeds being dependent on a traffic congestion status of the neighborhood around the candidate site;
route determination means for determining coverable routes or reachable points which can be covered or reached from the candidate site for the new store within a predetermined time period, based on the traveling speeds on the roads acquired by the traveling speed acquisition means; and
commercial area judgment means for judging a set of areas spreading along the coverable routes or a set of areas defined based on the reachable points, which are determined by the route determination means, as a commercial area to be formed if the new store is opened at the candidate site.

12. A marketing support program for supporting marketing,
the marketing support program causing a computer to execute the processing steps of:
receiving an input of a candidate site for a new store for map information;
acquiring traveling speeds at which predetermined transportation means can travel along respective roads in a neighborhood around the candidate site for the new store, the traveling speeds being dependent on a traffic congestion status of the neighborhood around the candidate site for the new store;
determining coverable routes or reachable points which can be covered or reached from the candidate site for the new store within a predetermined time period, based on the traveling speeds on the roads; and
judging a set of areas spreading along the covetable routes or a set of areas defined based on the reachable points, as a commercial area to be formed if the new store is opened at the candidate site.

13. A computer-readable recording medium storing a travelable range calculation program for calculating a travelable range,
the travelable range calculation program causing a computer to execute the processing steps of:
receiving an input for designating a travel start position for map information;
acquiring traveling speeds at which predetermined transportation means can travel along respective roads in a neighborhood around the input travel start position, the traveling speeds being dependent on a traffic congestion status of the neighborhood around the input travel start position; and
determining coverable routes or reachable points which can be covered or reached from the travel start position within a predetermined time period, based on the traveling speeds on the roads.

14. A computer-readable recording medium storing a marketing support program for supporting marketing,
the marketing support program causing a computer to execute the processing steps of:
receiving an input of a candidate site for a new store for map information;
acquiring traveling speeds at which predetermined transportation means can travel along respective roads in a neighborhood around the candidate site for the new store, the traveling speeds being dependent on a traffic congestion status of the neighborhood around the candidate site for the new store;
determining coverable routes or reachable points which can be covered or reached from the candidate site for the new store within a predetermined time period, based on the traveling speeds on the roads; and
judging a set of areas spreading along the coverable routes or a set of areas defined based on the reachable points, as a commercial area to be formed if the new store is opened at the candidate site.
